(19) United States
(12) Patent Application Publication
(10) Pub. No.: US 2001/0016890 A1
(43) Pub. Date: Aug. 23, 2001

(54) Interface distinguishing apparatus

(75) Inventor: Yuko Sonoda, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/771,301

(22) Filed: Jan. 25, 2001

(30) Foreign Application Priority Data
Feb. 7, 2000 (JP) 2000-029014

(51) Int. Cl. G06F 13/00; G06F 13/38

(52) U.S. Cl. 710/129

(57) ABSTRACT

In order to determine, where a terminal device and a computer main frame are connected by a PS/2 interface or a USB interface, which interface is connected, the main frame and the terminal device monitor the states of two signal lines after the PS/2 or USB interface is connected to a port of the terminal device, and the interface is determined to be one for PS/2 use if the states are (H, H) or (H, L). If the states are (L, L), a distinguishing signal assigning section on the terminal device side turns on a switching means to give an H signal to the signal lines.

### BACKGROUND OF THE INVENTION

1. Field of the Invention

The present invention relates to an interface distinguishing apparatus which, when a terminal device, such as a keyboard, to which, for instance, PS/2 and USB interfaces are connectable, is connected to a computer main frame via one of these interfaces, can automatically distinguish the type of interface via which the terminal device is connected.

2. Description of the Related Art

Keyboards and mice are extensively used for inputting data to computers. With such a keyboard or a mouse, an interface known as a Personal System/2 (PS/2) is mainly used. In recent years, however, in place of PS/2 interfaces, different interfaces known as universal serial bus (USB) have come to be increasingly used with keyboards, mice or other peripheral devices.

If a PS/2 interface is to be used, it is connected to a PS/2 port provided in advance on a computer main frame or, if a USB interface is to be used, it is connected to a USB port.

However, in the above-described configuration, it is impossible to use a conventional PS/2 interface-compatible keyboard unit (the terminal device) if a PS/2 port ceases to be provided on the computer (the main frame), resulting in the inconvenience that a USB interface-compatible keyboard unit has to be newly purchased. To eliminate this inconvenience, there is available a keyboard unit provided with both a PS/2 interface and a USB interface. Where such a keyboard unit is used, it is necessary to determine on the keyboard unit side whether it is connected to the computer main frame via the PS/2 port or via the USB port.

Although the PS/2 interface and the USB interface are entirely different from each other in connector shape and data format, they have common features that power is supplied from the main system to the terminal device and that two signal lines are used.

Therefore, even if only a dedicated PS/2 port is provided on the terminal side, the use of a conversion cable would enable USB signals to be inputted and outputted via a dedicated PS/2 port, and there also is a keyboard unit which realizes a USB interfacing function by appropriately processing signals within the terminal.

In this case, however, it is necessary to determine on the keyboard unit side whether a dedicated PS/2 cable or a conversion cable is connected to the dedicated PS/2 port.

### SUMMARY OF THE INVENTION

The present invention is intended to solve this problem with the prior art, and the object of the present invention is to provide an interface distinguishing apparatus which enables both a computer main frame and a terminal device to automatically determine whether a PS/2 interface or a USB interface is connected by merely connecting a cable between the computer main frame and the terminal device.

According to the invention, there is provided an apparatus in which a terminal permitting data inputting/outputting via a first interface and data inputting/outputting via a second interface can be connected to both a first port for the first interface and a second port for the second interface on a main frame side, wherein:

both the first interface and the second interface have two signal lines each; the first port has a circuit which holds, when the combination of the potentials of the two signal lines is determined and the potential of one of the signal lines is varied, that potential; and the second port permits setting of diverse combinations of the potentials of the two signal lines including the combination of potentials of the first port and has a circuit which can return the varied potentials of the signal lines to their original potentials; and

there is provided a distinguishing means for varying on the terminal side, when a state in which the terminal is connected to either one of the ports or a state in which the power supply to the main frame is turned on after that connection is recognized on the terminal side and the potentials of the port are recognized to be the combination of potentials of the first interface, the potential of either signal line and determining whether the first port or the second port is used on the main frame side according to whether or not the varied potential is held.

According to the invention, even where, for instance, only a dedicated PS/2 input/output port is provided on the terminal side, inputting/outputting of USB standard signals is made possible by using a conversion cable, and it is possible to determine whether a PS/2 interface is connected by a dedicated PS/2 cable or a USB interface is connected via a conversion cable between the terminal and the computer main frame, or where both a PS/2 port and a USB port are provided on the terminal side, it is made possible to determine which interface is connected to which port.

Further according to the invention, not only in the case of connection of a cable but also in the case of turning-on of power supply, distinction can be carried out, so that stable communication can be ensured all the time.

There is provided on the terminal, for instance, a switching means for switching the potential of either signal line to H when a state in which the potentials of both signal lines of the first port are L and the terminal is connected to either port or a state in which power supply to the main frame is turned on is recognized on the terminal side after the connection and the potentials of both signal lines of the port are recognized to be L, and the distinguishing means identifies the first port if the potential of the signal line holds H or identifies the second port if the potential of the signal line returns to L.

It is preferable for the switching means in the foregoing to be positioned between resistors to pull up one of the signal lines and the power supply line.

Where, for instance, the two signal lines conform to the USB standard, it is necessary on the terminal side to pull up either signal line according to the data transfer speed. For this reason, the switching means can be used both as means to distinguish one interface from the other and means to pull up a USB signal line.

Thus, of these interfaces, the first is a USB interface with two signal lines being a D− signal line and a D+ signal line, and the second is a PS/2 interface with two signal lines being a Data signal line and a CLK signal line.

In this case, where the main frame connected to the terminal is provided with a USB interface, the switching means resistance-divides the potential of either the D− signal line or the D+ signal line of the first interface into the H level output potential of a differential input signal.

The computer main frame and the terminal device, following the connection of a cable or after the lapse of a certain period of time from the turning-on of power supply, periodically monitor the two signal lines (the D− signal line and the D+ signal line), and can immediately determine connection to the first port (the first interface (PS/2)) unless both of the two signal lines are at an L level.

Alternatively, if, after monitoring for a certain period of time, the switching means is operated after confirming that both of the two signal lines are at an L level, distinction between the first port and the second port can be made without fail.

The combination of the potentials of the two signal lines of the second port for PS/2 use may be L and L, H and L or H and H.

Further, where the terminal is a device in a low speed mode, it is preferable for the switching means to give H to the D− signal line, or where the terminal is a device in a high speed, it is preferable for the switching means to give H to the D+ signal line.

As described above, it is made possible to select a data transfer speed matching the type of the terminal device. For instance, for a keyboard or a mouse unit, the data transfer speed can be set low, while the data transfer speed can be set high for a terminal device handling a large quantity of data, such as a floppy disk drive, a scanner unit or a digital camera.

### BRIEF DESCRIPTION OF THE DRAWINGS

FIG. 1 illustrates the configuration of computer main frames and a terminal device.

FIG. 2 illustrates the configuration of the interface on the computer main frame side.

FIG. 3 illustrates the circuitry of the interface on the terminal device side.

### DETAILED DESCRIPTION OF THE PREFERRED EMBODIMENT

A preferred embodiment of the present invention will be described in detail below with reference to the accompanying drawings.

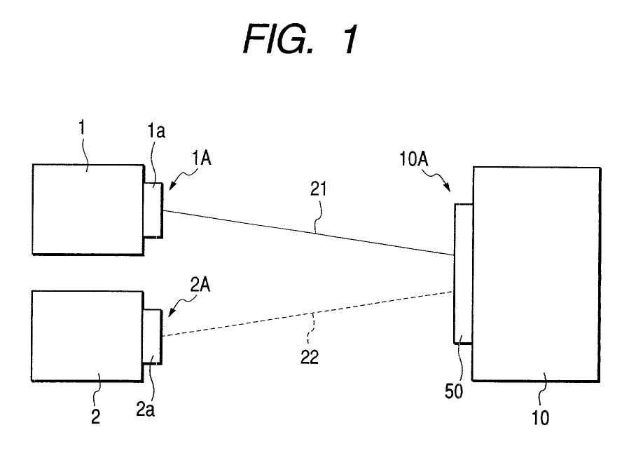

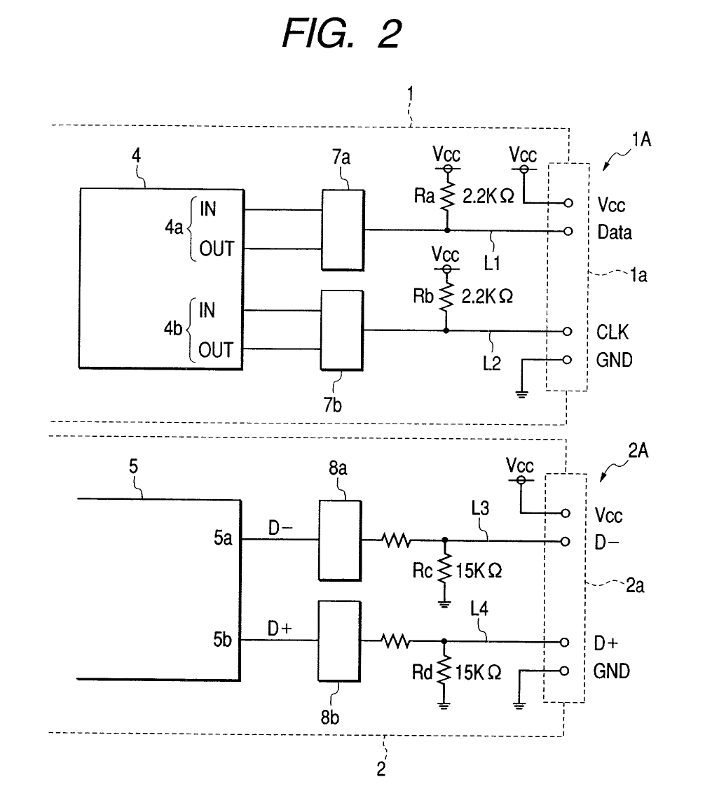

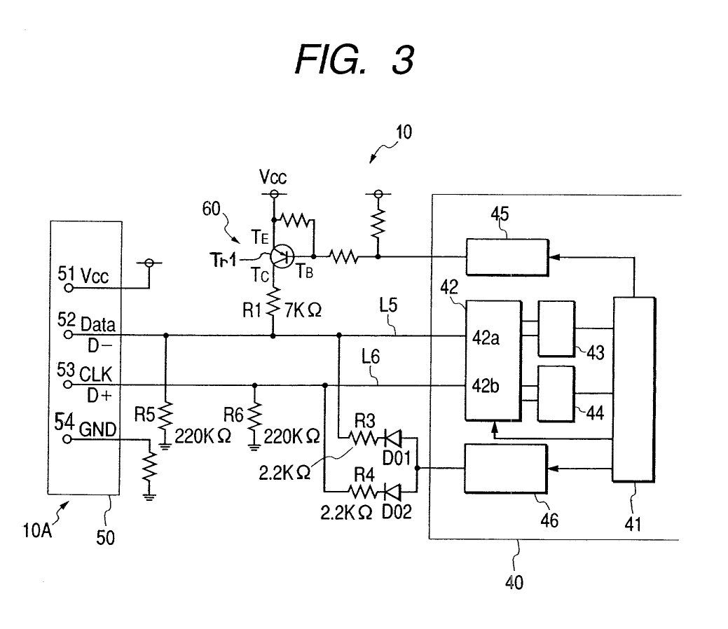

FIG. 1 illustrates the configuration of computer main frames and a terminal device. FIG. 2 illustrates the configuration of the interface on the computer main frame side. FIG. 3 illustrates the circuitry of the interface on the terminal device side.

As shown in FIG. 1, one computer main frame 1 is provided with a PS/2 port 1A, while the other computer main frame 2 is provided with a USB port 2A. On the terminal device 10 side is provided a port 10A. The terminal device 10 may be, for example, a keyboard unit, a mouse unit, a floppy disk drive or a scanner unit.

By connecting a PS/2 cable 21 between the computer main frame 1 and the terminal device 10 and connecting a conversion cable 22 between the computer main frame 2 and the terminal device 10, communication is made possible between them.

As shown in FIG. 2, the PS/2 port 1A of the computer main frame 1 and the port 10A of the terminal device 10 are provided with round six-pin structured connectors 1a and 50, respectively. The pin arrangement is such that a first pin is for Data (Data1 signal), a third pin is for the ground (GND), a fourth pin is for a source voltage Vcc (+5VDC), and a fifth pin is for a clock (CLK1 signal). Second and sixth pins are unoccupied, so that the structure has in effect only four pins.

On the other hand, the USB port 2A of the computer main frame 2 is provided with a rectangular four-pin structured connector 2a. In the pin arrangement, a pair of signal terminals D− and D+ and a pair of power supply terminals Vcc and GND constitute the four-pin structure.

The signal levels of Data1 and CLK1 of the PS/2 are TTL level outputs (0-5 V). The signals D− and D+ of the USB are differential signal outputs, whose signal output levels are in a range of an L level output of no more than 0.3 V and an H level output of 2. 8V to 3.6 V.

Incidentally, the communication cable 21 for connecting the connector 1a of the computer main frame 1 and the connector 50 of the terminal device 10 is provided with a PS/2 connector at each of its both ends. On the other hand, the conversion cable 22 for connecting the connector 2a of the computer main frame 2 and the connector 50 of the terminal device 10 has a PS/2 connector at its one end and a USB connector at the other end. This cable connects the power supply terminal Vcc on one side to that on the other and the ground terminal GND on one side to the other, the Data terminal to the D− terminal and the CLK terminal to the D+ terminal.

As shown in FIG. 2, the computer main frame 1 is provided with a communication control means 4 for controlling communication on the basis of a PS/2 protocol as instructed by a CPU. The communication control means 4 of the computer main frame 1 has a Data input/output section 4a and a CLK input/output section 4b, and performs input/output control of the Data signal and the CLK signal between the computer main frame 1 and the terminal device 10 on the basis of the PS/2 protocol. Between the communication control means 4 and the connector 1a are provided buffer means 7a and 7b. The buffer means 7a is provided on a Data line L1 between the Data input/output section 4a of the communication control means 4 and the connector 1a. The buffer means 7b is provided on a CLK line L2 between the CLK input/output section 4b of the communication control means 4 and the connector 1a. Both the Data line L1 and the CLK line L2 are pulled up by pull-up resistors Ra and Rb (both 2.2 KΩ) relative to the power source Vcc.

On the other hand, the computer main frame 2 is provided with a communication control means 5 for controlling communication on the basis of a USB protocol as instructed by the CPU. The communication control means 5 has a D− input/output section 5a and a D+ input/output section 5b, and performs input/output control between the computer main frame 2 and the terminal device 10. Between the communication control means 5 and the connector 2a are provided buffer means 8a and 8b. The buffer means 8a is provided on a D− line L3 connecting the D− input/output section 5a of the communication control means 5 and the D− terminal of the connector 2a. The buffer means 8b is provided on a D+ line L4 connecting the D+ input/output section 5b and the D+ terminal of the connector 2a. The D− line L3 and the D+ line L4 are connected to the ground GND by pull-down resistors Rc and Rd (both 15 KΩ). Therefore, when the connector 2a is not connected, the D− terminal and the D+ terminal are in a high impedance state, and the D− line L3 and the D+ line L4 are at an L level (GND potential).

As shown in FIG. 3, on the terminal device 10 side are provided the connector 50 and a distinguishing means 40. The connector 50 is provided with a power supply input terminal 51, signal input/output terminals 52 and 53, and a grounding input terminal 54.

The distinguishing means 40 is provided with a general control section 41 exercising general control over the distinguishing means 40, a switching section 42, a PS/2 controller 43, a USB controller 44, a distinguishing signal assigning section 45 and a voltage supplying section 46.

The signal input/output terminals 52 and 53 of the connector 50 are connected to the switching section 42 via signal lines L5 and L6, respectively. The switching section 42 is so set as to connect the signal lines L5 and L6 to the PS/2 controller 43 side in a default state. When the connector 50 is connected to the computer main frame 2 via the conversion cable 22, i.e. when the USB interface is used, the switching section 42 so operates as to switch the signal lines L5 and L6 over to the USB controller 44 side.

The distinguishing signal assigning section 45, upon receiving an instruction from the general control section 41, sets the output to the L level potential, and the voltage supplying section 46, at the instruction of the general control section 41, supplies a prescribed voltage (source voltage Vcc).

Incidentally, the signal lines L5 and L6 are connected to the ground GND via pull-down resistors R5 and R6 (both 220 KΩ) . The power supply input terminal 51 is connected to a power supply line within the terminal device 10, and similarly a grounding input terminal 54 is connected to a grounding line within the terminal device 10. Power is supplied to the terminal device 10 side from the computer main frame 1 or 2 via the power supply input terminal 51 and the grounding input terminal 54 of the connector 50.

Further as shown in FIG. 3, the distinguishing means 40 of the terminal device 10 is provided with a switching means 60. The switching means 60 consists of, for instance, a pnp bipolar type transistor Tr1 and a plurality of resistors. The collector terminal Tc of the transistor Tr1 is connected to, for instance the signal line L5, and the base terminal TB is connected to the distinguishing signal assigning section 45. The emitter terminal TE of the transistor Tr1 is connected to the power source Vcc.

Further, the output of the voltage supplying section 46 is connected to the signal lines L5 and L6 via diodes DO1 and DO2 and pull-up resistors R3 and R4, respectively. The pull-up resistor R1 should preferably be about 7 KΩ, and the pull-up resistor R3 and R4, both 2.2 KΩ.

The operation of the interface distinguishing apparatus configured above will be described below.

(1) Where no cable is connected:

First, where there is no connection between the terminal device 10 and the computer main frame 1 or the computer main frame 2, the following state will prevail.

To denote the states of the Data line L1 and the CLK line L2 of the PS/2 port 1A of the computer main frame 1 by Q1 (Data1, CLK1), Q1 (Data1, CLK1) can be set in one of three ways (H, H), (L, L) and (H, L) depending on how the computer is started up, where H represents an H level output and L, an L level output.

To denote the states of the D− line L3 and the D+ line L4 of the USB port 2A of the computer main frame 2 by Q2 (D−, D+), Q2 (D−, D+)= (L, L).

On the other hand, to denote the states of the I/O sections 42a and 42b of the switching section 42 of the terminal device 10 (the states of the signal lines L5 and L6) by Q3 (D1, D2), the states of the both the I/O sections 42a and 42b are indefinite (Q3 (D1, D2)= indefinite) because no power from the computer main frame 1 or 2 is supplied to the terminal device 10 side.

The computer main frame 1 monitors the states of the Data line L1 and the CLK line L2 (Q1 (Data1, CLK1)), the computer main frame 2 monitors those of the D− line L3 and the D+ line L4 (Q2 (D−, D+)), and the terminal device 10 monitors those of the I/O sections 42a and 42b (Q3 (D1, D2)).

These states can be put in order as shown in Table 1 below.

TABLE 1

| Q1 | Q2 | Q3 |
|---|---|---|
| (Data 1, CLK1) | (D−, D+) | (D1, D2) |
| (H, H) | (L, L) | Indefinite |
| (H, L) | | |
| (L, L) | | |

(2) Where the PS/2 communication cable 21 is connected:

Next, when the connector la of the computer main frame 1 and the connector 50 of the terminal device 10 are connected by the PS/2 cable 21, the Data line L1 on the computer main frame 1 side and the signal line L5 on the terminal device 10 are connected, and so are the CLK line L2 on the computer main frame 1 side and the signal line L6 on the terminal device 10 side. Thus the Data input/output section 4a and the CLK input/output section 4b of the communication control means 4 on the computer main frame 1 side and the I/O sections 42a and 42b of the switching section 42 on the terminal device 10 side are connected, respectively.

As a result, the state Q1 (Data1, CLK1) of the Data line L1 and the CLK line L2 of the computer main frame 1 and the state Q3 (D1, D2) of the signal lines L5 and L6 on the terminal device 10 side are set to be identical (Q1 (Data1, CLK1)= Q3 (D1, D2)).

Incidentally, whereas the state described above refers to the state in which the PS/2 cable 21 is connected between the connector 1a on the computer main frame 1 side to which power supply is already on and the connector 50 on the terminal device 10 side, the state immediately after the turning-on of power supply to the computer main frame 1 to which the cable 21 is already connected is the same.

Therefore the states immediately after connection by the PS/2 communication cable 21 can be put in order as shown in Table 2 below. As the computer main frame 2 side is not yet connected, Q2 (D1, D2) does not vary.

TABLE 2

| Q1 | Q2 | Q3 |
|---|---|---|
| (Data1, CLK1) | (D−, D+) | (D1, D2) |
| (H, H) | (L, L) | (H, H) |
| (H, L) | | (H, L) |
| (L, L) | | (L, L) |

(3) Where the USB conversion cable 22 is connected

When, from the state of (1) above in which no cable is connected, the connector 2a on the computer main frame 2 side and the connector 50 on the terminal device 10 side are connected by the conversion cable 22, the power source Vcc and the ground GND are connected to their respective counterparts. The D− line L3 and the D+ line L4 on the computer main frame 2 side and the signal lines L5 and L6 on the terminal device 10 side are respectively connected. As a result, the state Q2 (D−, D+) of the D− line L3 and the D+ line L4 on the computer main frame 2 side and the state Q3 (D1, D2) of the signal lines L5 and L6 of the distinguishing means 40 on the terminal device 10 side are set to be identical (Q2 (D−, D+ )= Q3 (D1, D2)).

In this state, the D− line L3 (signal line L5) is connected to the ground GND by the parallel resistor of the pull-up resistor Rc and pull-up resistor R5, and so is the D+ line L4 (signal line L6) by the parallel resistor of the pull-up resistor Rd and pull-up resistor R6. As a result, both the state Q2 (D−, D+) and the state Q3 (D1, D2) become identical to Q1 (D−, D+)= Q3 (D1, D2)= (L, L).

Further as the PS/2 port of the computer main frame 1 is not yet connected, the state Q1 (Data1, CLK1) of the Data line L1 and the CLK line L2 is equal to (H, H) or (H, L) or (L, L).

These states are shown in Table 3.

TABLE 3

| Q1 | Q2 | Q3 |
|---|---|---|
| (Data1, CLK1) | (D−, D+) | (D1, D2) |
| (H, H) | (L, L) | (L, L) |
| (H, L) | | |
| (L, L) | | |

(4) Interface distinguishing action

When the cable 21 is connected from the unconnected state, the states Q1 (Data1, CLK1) and Q3 (D1, D2) are set to Q1 (Data1, CLK1)= Q3 (D1, D2)= (H, H) or (H, L) or (L, L) as shown in Table 1 or Table 2 above.

On the other hand, when the conversion cable 22 is connected from the unconnected state, the states of the I/O sections 42a and 42b of the switching section 42 on the terminal device 10 side are always Q3 (D1, D2)= (L, L), but there is no case of Q3 (D1, D2)= (H, H) or (H, L).

Therefore, if immediately after the communication cable 21 or the conversion cable 22 is connected between either computer main frame and the terminal device 10, the state Q3 (D1, D2)= (H, H) or (H, L) is detected on the terminal device 10 side, and it can be immediately determined that the terminal device 10 is connected by the communication cable 21 to the PS/2 port 1A of the computer main frame 1.

Incidentally, the foregoing also holds true of a case in which the source voltage is actuated from a state wherein the communication cable 21 is already connected, and power is supplied to the terminal device 10 side to start periodic monitoring by the general control section 41 on the terminal device 10 side.

Then, when the computer main frame 2 and the terminal device 10 are connected by the conversion cable 22 as shown in Table 3, the state Q2 (D−, D+) of the computer main frame 2 and the state Q3 (D1, D2) of the terminal device become identical: Q2 (D−, D+)= Q3 (D1, D2)= (L, L). Also in a state wherein the computer main frame 1 and the terminal device 10 are connected as shown in Table 2, Q3 (D1, D2)= (L, L) may hold true. Therefore, when Q3 (D1, D2)= (L, L) is detected on the terminal device 10 side, it is impossible to determine whether the PS/2 cable 21 is connected or the conversion cable 22 for USB use is connected. Therefore in this case, distinguishing is accomplished in the following manner.

The distinguishing means 40 on the terminal device 10 side supplies from its distinguishing signal assigning section 45 a stepwise L level signal after the lapse of a prescribed length of time (e.g. 100 msec) from the connection of a cable, and turns on the switching means 60. This causes a current to flow from the power source Vcc to the signal line L5 to place this signal line L5 in a pulled-up state. Incidentally, the use of a USB interface means that a stepwise H level signal is given as the D− signal substantially on the USB protocol.

If the USB conversion cable 22 is connected in this case, the signal line L5 is set to a voltage level of about 3.3 V. The voltage level of the signal line L5 is determined by the resistance-voltage division ratio between the parallel pull-down resistor Rc and pull-down resistor R5 on the one hand and the pull-up resistor R1 on the other, and since the resistance-voltage division ratio in the above-cited case (Rc= 15 KΩ, R1=7 KΩ, R5=220 KΩ) is about ⅔, the voltage level of the signal line L5 is about 3.3 V when the source voltage Vcc is 5V (TTL level) . Incidentally, the voltage level of this signal line L5 is within the range of the H level output (2.8 V to 3.6 V) on the USB protocol, and detection of this H level output by the computer main frame 2 and the terminal device 10 makes it possible to determine the connected cable to be the conversion cable 22. This enables the terminal device 10 to judge that connection to the port 2A of the computer main frame 2 has been accomplished by means of the USB interface.

On the other hand, if after the signal line L5 is pulled up by the switching means 60 the voltage level of the signal line L5 is held at the L level of the ground GND potential (=0 V), the terminal device 10 is determined to be connected to the PS/2 port 1A on the computer main frame 1 side via the PS/2 communication cable 21.

Thus, as the Data line L1 on the computer main frame 1 side and the signal line L5 on the terminal device 10 side are connected when the connected cable is the communication cable 21, the voltage level (potential) of the signal line L5 (Data line L1) is determined by the resistance-voltage division ratio between the parallel pull-up resistor Ra and pull-up resistor R1 on the one hand and the pull-down resistor R5 on the other. However, since the Data line L1 is pulled to the L level in the state of Q1 (Data1, CLK1)= Q3 (D1, D2)= (L, L), the state of Q1 (Data1, CLK1)= Q3 (D1, D3)= (L, L) is maintained.

Once the PS/2 interface is distinguished by the above-described procedure, the general control section 41 of the distinguishing means 40 inverts the output of the distinguishing signal assigning section 45 to an H level output to turn off the switching means 60. Further, a voltage of 5 V corresponding to the power source voltage Vcc is supplied from the voltage supplying section 46, and the signal lines L5 and L6 are pulled up by the pull-up resistors R3 and R4. The communication in conformity with the PS/2 protocol is started via the PS/2 controller 43.

If the above-described procedure distinguishes the USB interface, the output of the distinguishing signal assigning section 45 is maintained at the L level, and the state in which the signal line L5 (D−) is pulled up is maintained. Then the general control section 41 of the distinguishing means 40 on the terminal device 10 side switches over the switching section 42 to select the USB controller 44, thereby enabling communication based on the USB protocol to take place between the computer main frame 2 and the terminal device 1.

In the above-described embodiment of the invention, as the signal line D− on the USB protocol is pulled up, the data transfer speed is set in a low speed mode of 1.5 Mbits/s, which matches a keyboard unit or a mouse unit.

On the other hand, by pulling up the D+ signal line L6 side instead of pulling up the D− line L5, the data transfer speed can be set to a high speed mode of 12 Mbits/s, which matches a floppy disk drive or a scanner unit.

Although connection to the PS/2 interface or the USB interface on the main frame side is accomplished via one port 10A of the terminal device 10 in the above-described embodiment, the configuration may as well be such that both a PS/2 interface and a USB interface port are provided on the terminal device 10 side, and can be switched between each other with a switching section provided within the distinguishing means 40.

According to the present invention hitherto described in detail, it is possible to determine whether a PS/2 interface or a USB interface is connected by merely connecting a terminal device to the computer main frame.

Furthermore, signal lines can be pulled up to a prescribed voltage level matching each interface protocol.

Where a USB interface is used, the data transfer speed can be set in a mode matching the given terminal device.

What is claimed is:

1. An interface distinguishing apparatus in which a terminal permitting data inputting/outputting via a first interface and data inputting/outputting via a second interface can be connected to both a first port for the first interface and a second port for the second interface on a main frame side, wherein:
both the first interface and the second interface have two signal lines each; the first port has a circuit which holds, when the combination of the potentials of the two signal lines is determined and the potential of one of the signal lines is varied, that potential; and the second port permits setting of diverse combinations of the potentials of the two signal lines including the combination of potentials of the first port and has a circuit which can return the varied potentials of the signal lines to their original potentials; and
there is provided a distinguishing means for varying on the terminal side, when a state in which the terminal is connected to either one of the ports or a state in which the power supply to the main frame is turned on after the connection is recognized on the terminal side and the potentials of the port are recognized to be the combination of potentials of the first interface, the potential of either signal line and determining whether the first port or the second port is used on the main frame side according to whether or not this varied potential is held.

2. The interface distinguishing apparatus according to claim 1, wherein a switching means for switching the potential of either signal line to H when a state in which the potentials of both signal lines of the first port are L and the terminal is connected to either port or a state in which power supply to the main frame is turned on is recognized on the terminal side after the connection and the potentials of both signal lines of the port are recognized to be L, and the distinguishing means identifies the first port if the potential of the signal line holds H or identifies the second port if the potential of the signal line returns to L.

3. The interface distinguishing apparatus according to claim 2, wherein the switching means is positioned between resistors to pull up one of the signal lines and the power supply line.

4. The interface distinguishing apparatus according to claim 2, wherein the first interface is a USB interface with two signal lines being a D− signal line and a D+ signal line, and the second interface is a PS/2 interface with two signal lines being a Data signal line and a CLK signal line.

5. The interface distinguishing apparatus according to claim 2, wherein, if the main frame connected to the terminal is provided with a USB interface, the switching means resistance-divides the potential of either the D− signal line or the D+ signal line of the first interface into the H level output potential of a differential input signal.

6. The interface distinguishing apparatus according to claim 4, wherein the combination of the potentials of the two signal lines of the second port for PS/2 use may be L and L, H and L or H and H.

7. The interface distinguishing apparatus according to claim 4, wherein, if the terminal is a device in a low speed mode, the switching means gives an H level to the D− signal line.

8. The interface distinguishing apparatus according to claim 4, wherein, if the terminal is a device in a high speed, the switching means gives an H level to the D+ signal line.
